(19) United States
(12) Patent Application Publication
(10) Pub. No.: US 2026/0337941 A1
(43) Pub. Date: Oct. 29, 2026

(54) BIDET

(71) Applicant: COWAY CO., LTD., Gongju-si (KR)

(72) Inventors: Sung Hee LEE, Seoul (KR); Sung Worl JIN, Seoul (KR); Seon Yong JEONG, Seoul (KR); Doo Youl JEON, Seoul (KR); Jong Hyun PARK, Seoul (KR); Seong Eun LIM, Seoul (KR); Jae Hong LEE, Seoul (KR); Young Ju KIM, Seoul (KR)

(73) Assignee: COWAY CO., LTD., Gongju-si (KR)

(21) Appl. No.: 19/139,080

(22) PCT Filed: Dec. 8, 2023
(86) PCT No.: PCT/KR2023/020262

§ 371 Date: Jun. 13, 2025

(30) Foreign Application Priority Data
Dec. 16, 2022 (KR) 10-2022-0177049

(51) Int. Cl. E03D 9/08

(52) U.S. Cl. CPC E03D 9/08

(57) ABSTRACT

A bidet includes a nozzle for discharging a liquid to the front, a circuit board for controlling the nozzle or supplying power to the nozzle, a housing assembly containing the circuit board; and a cable for supplying power to the circuit board. The housing assembly includes a body portion supporting the nozzle, and a cable guide. The cable includes a first section extending from the rear end of the housing assembly while being positioned outside the housing assembly, and a second section positioned inside the housing assembly to connect the first section and the circuit board. The cable guide includes a first guide portion that guides the first section to extend from the rear end of the body portion toward a left or right side of the body portion such that the direction of extension can be changed toward the other of the left and right sides.

### TECHNICAL FIELD

The present disclosure relates to a bidet.

### BACKGROUND ART

A bidet can be installed on a toilet bowl to automatically perform anal and feminine cleansing by spraying cleaning water through a nozzle. After the cleansing with cleaning water is completed, the bidet can be operated so that a drying device provided inside the bidet blows air to dry the cleansed region. Further, various components such as a motor, a heating device, and a nozzle, which are powered electrically, are accommodated inside the bidet. In addition, the bidet may be provided with a power cord for supplying power to these components. In conventional bidets, the power cord is directly connected between an upper housing and a lower housing constituting a bidet housing through ribs formed in the upper housing and the lower housing, and there is a risk that water may flow into the housing through the gap between the upper housing and the lower housing along a power cord mounting portion, causing various safety issues such as electric shock.

As a technique to prevent water from flowing into the housing along the power cord mounting portion, Korean Patent Application Publication No. 10-2018-0076576 entitled “Bidet” (hereinafter, Patent Document 1) of the present applicant discloses a bidet including a housing that accommodates bidet components, a power cord for supplying power to the bidet components, and a cover that is coupled to the housing and supports the power cord together with the housing.

However, since the power cord of the bidet disclosed in Patent Document 1 is configured to protrude from either the left or right side of the housing through the cover part, it is guided in only one direction (left or right), so there is a problem that when a wall outlet in a toilet is installed on the opposite side to where the power cord is located, the power cord needs to be extended to the opposite side. For example, in the bidet of Patent Document 1, if the power cord is installed on the right side of the bidet and the wall outlet in the toilet is located on the left side of the bidet, the power cord extending from the right side of the bidet should be routed toward the opposite side (left side) for connection to the outlet. As such, when the positions of the power cord of the bidet of Patent Document 1 and the wall outlet in the toilet are opposite to each other, it is inconvenient to connect the power cord to the outlet, and if the power cord is forcibly extended to the opposite side, the power cord may be deformed or damaged, which may cause a short circuit or fire.

### DETAILED DESCRIPTION OF INVENTION

### Technical Problems

One embodiment of the present disclosure provides a bidet that allows the extension direction of a cable to be changed by guiding a portion of the cable to selectively extend toward either the left or right side of a body part.

### Technical Solution

In accordance with one embodiment of the present disclosure, a bidet comprises: a nozzle for discharging liquid forward; a circuit board for controlling the nozzle or supplying power to the nozzle; a housing assembly accommodating the circuit board therein; and a cable for supplying power to the circuit board from an outside of the housing assembly, wherein the housing assembly includes a body part supporting the nozzle, and a cable guide for guiding an arrangement direction of the cable, wherein the cable includes: a first section disposed outside the housing assembly and extending from a rear end of the housing assembly; and a second section disposed inside the housing assembly and connecting the first section with the circuit board, wherein the cable guide includes a first guide part that guides an arrangement direction of the first section, and wherein the first guide part is configured to guide the first section to extend from a rear end of the body part toward one of a left side or a right side of the body part when viewed from the rear side of the bidet, and allow the arrangement direction of the first section to be changed to the other of the left side and the right side.

Further, the cable guide may further include a second guide part that guides an arrangement direction of the second section within the body part, and the second section extends in one direction different from an extension direction of the first section.

Further, the first section may be disposed behind the second section.

Further, the one direction may be an up-down direction.

Further, the first guide part may be disposed at a lower end portion of the body part.

Further, the first guide part may extend from the second guide part to the left side and the right side of the body part.

Further, the second guide part may include: a support that extends in the one direction and provides a support space for guiding the second section of the cable within the support; and a locking portion that protrudes from an inner side of the support and configured to engage with the second section of the cable.

Further, on the second section, a power bushing may be formed that is arranged in an up-down direction in the support space of the support and engages with the locking portion.

Further, the first guide part may include: a left guide portion which extends from a lower side of the second guide part toward the left side of the body part and provides a left guide space for accommodating the first section and guiding the first section to the left side of the body part; and a right guide portion which extends from the lower side of the second guide part toward the right side of the body part and provides a right guide space for accommodating the first section and guiding the first section to the right side of the body part.

Further, a length in a left-right direction of one of the left guide portion and the right guide portion may be formed to be longer than that of the other.

Further, the left guide portion and the right guide portion may be formed such that depths in a front-rear direction of the left guide space and the right guide space decrease as the distance from the second guide part increases.

Further, the housing assembly may further include a guide cover coupled to the first guide part to cover the first section arranged in the first guide part.

Further, the second guide part may be positioned inside the body part to be closer to a rear surface of the body part than to a front surface of the body part.

Further, the second guide part may guide the second section of the cable so that the second section does not overlap with an imaginary line extending in a front-rear direction from the nozzle.

### Effect of Invention

According to one aspect of the present disclosure, the guide part of the bidet guides a portion of the cable to be selectively extended toward the left or right side of the body part depending on the location of a wall outlet in a toilet, so that the bidet can be easily installed on the toilet bowl regardless of the location of the external outlet.

Further, since the cable can be supported by the guide part so that a portion of the cable and another portion of the cable adjacent thereto extend in different directions, the direction of the cable can be easily changed.

Furthermore, since the cable can be secured by engaging with the locking portion, the cable can be prevented from being separated from the cable guide due to the directional change of the first section.

In addition, since the guide cover can be coupled to the guide part, the cable can be prevented from being separated from the guide part while the extension direction of the cable is changed.

Further, since the guide part is positioned close to the rear surface of the body part, the cable can be restricted from moving rearward by the body part, which prevents the cable from being separated from the guide part.

### BRIEF DESCRIPTION OF THE DRAWINGS

FIG. 1 is a perspective view showing a bidet according to one embodiment of the present disclosure.

FIG. 2 is an exploded perspective view of the bidet shown in FIG. 1.

FIG. 3 is a top view showing a lower support member of the bidet in FIG. 2 as viewed from above.

FIG. 4 is a cross-sectional view of the bidet in FIG. 1, taken along line IV-IV.

### MODE FOR CARRYING OUT THE INVENTION

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘connected to’ another component, it may be directly connected to another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” used in the present specification specifies specific features, regions, integers, steps, operations, elements and/or components, and does not exclude the presence or addition of other specific features, regions, integers, steps, operations, elements, components, and/or groups.

Hereinafter, a bidet 1 according to one embodiment of the present disclosure will be described with reference to the drawings.

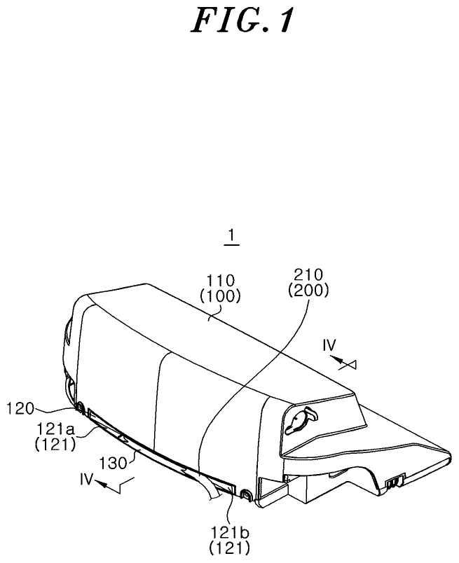

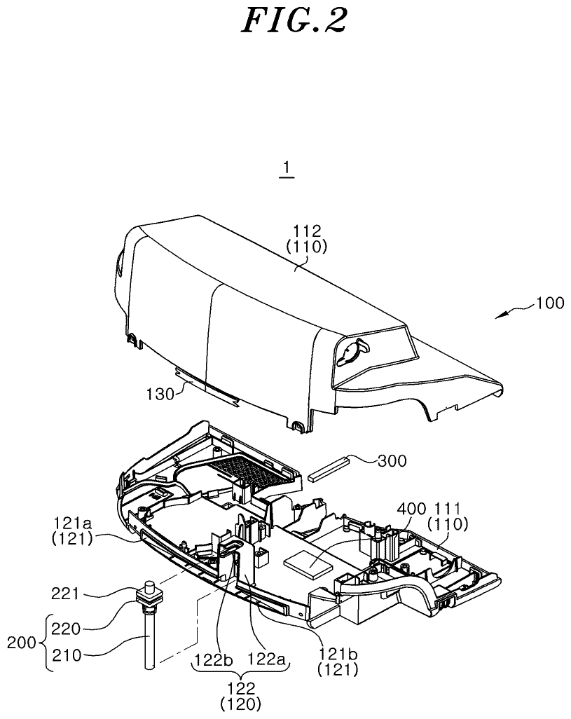

Referring to FIGS. 1 and 2, the bidet 1 according to one embodiment of the present disclosure may be mounted on a toilet bowl or formed integrally with the toilet bowl. In other words, the bidet 1 may be included in an integrated toilet bowl. In addition, the bidet 1 may discharge a cleaning liquid to wash the toilet bowl or provide a liquid, wind, or the like to a user. The bidet 1 may include a housing assembly 100, a cable 200, a nozzle 300, and a circuit board 400.

The housing assembly 100 may accommodate the nozzle 300, a fan (not shown) for providing wind to a user, and the circuit board 400 therein. In addition, the housing assembly 100 may be formed to accommodate a portion of the cable 200, while allowing another portion of the cable 200 to be guided toward an outlet (not shown) located outside the bidet 1. The housing assembly 100 may include a body part 110, a cable guide 120, and a guide cover 130.

The body part 110 may provide an accommodation space for accommodating the nozzle 300 and the circuit board 400. In other words, the body part 110 may be a housing that forms the outer appearance of the housing assembly 100. In addition, the body part 110 can be mounted on a toilet bowl. Through the body part 110, the nozzle 300 can be supported by the body part 110 to be movable in a front-rear direction. The body part 110 may include a lower support member 111 and an upper housing 112.

The lower support member 111 may support the cable guide 120, the nozzle 300, and the circuit board 400. In other words, the cable guide 120, the nozzle 300, and the circuit board 400 may be arranged on an upper surface of the lower support member 111.

The upper housing 112 may be coupled to the lower support member 111 to form the accommodation space of the body part 110. The upper housing 112 may be coupled to the lower support member 111 to cover the nozzle 300 and the circuit board 400, but to expose a portion of the cable guide 120 to the outside. In addition, the upper housing 112 and the lower support member 111 may be coupled so as to surround a peripheral surface of a first guide part 121 of the cable guide 120, which will be described later. In other words, a stepped portion may be formed at a lower end of the upper housing 112 to be spaced upward from the lower support member 111 while surrounding the peripheral surface of the first guide part 121.

The cable guide 120 can guide the arrangement direction of the cable 200. In other words, the cable guide 120 can guide the arrangement direction of the cable 200 to direct the cable 200 toward an outlet located outside the bidet 1. For example, when the outlet is located on the right side of the bidet 1, the cable guide 120 can guide the cable 200 to the right, and when the outlet is located on the left side of the bidet 1, the cable guide 120 can guide the cable 200 to the left. The cable guide 120 may be disposed at a rear side of the body part 110. The cable guide 120 may include a first guide part 121 and a second guide part 122.

The first guide part 121 can guide the arrangement direction of a first section 210 of the cable 200, which will be described later. The first guide part 121 is supported by the lower support member 111, and can guide the first section 210 to extend toward either the left or right side of the body part 110. In other words, the first guide part 121 may extend in a left-right direction in a rear surface of the body part 110, and provide a guide space in which the first section 210 can be accommodated. In addition, the first guide part 121 may extend from the second guide part 122 to the left and right sides of the body part 110.

Further, the first guide part 121 may be positioned between the lower support member 111 and the upper housing 112 so that the guide space is exposed to the outside. Through this guide space, the first section 210 can also be exposed to the outside, so that a user can change the orientation of the first section 210 arranged toward the left side of the body part 110 to be arranged toward the right side of the body part 110. In other words, the first guide part 121 may be configured to allow the extension direction of the first section 210 to be changed to either the left side or the right side of the body part 110. In addition, the first guide part 121 may include a left guide portion 121a and a right guide portion 121b.

The left guide portion 121a may extend from the lower side of the second guide part 122 toward the left side of the body part 110 when viewed from the rear side of the bidet 1. In other words, when viewed from the rear side of the housing assembly 100, the left guide portion 121a may extend from the lower side of the second guide part 122 toward the left side of the body part 110. In addition, the left guide portion 121a may provide a left guide space for accommodating the first section 210 and guiding it toward the left side of the body part 110.

The right guide portion 121b may extend from the lower side of the second guide part 122 toward the right side of the body part 110 when viewed from the rear side of the bidet 1. In other words, when viewed from the rear side of the housing assembly 100, the right guide portion 121b may extend from the lower side of the second guide part 122 toward the right side of the body part 110. In addition, the right guide portion 121b may provide a right guide space for accommodating the first section 210 and guiding it toward the right side of the body part 110.

The length in the left-right direction of either the left guide portion 121a or the right guide portion 121b may be formed longer than the other. In other words, the length of the left guide portion 121a in the left-right direction may be formed longer than that of the right guide portion 121b. In addition, the left guide portion 121a and the right guide portion 121b may be formed such that the depths in the front-rear direction of the left guide space and the right guide space decrease as the distance from the second guide part 122 increases.

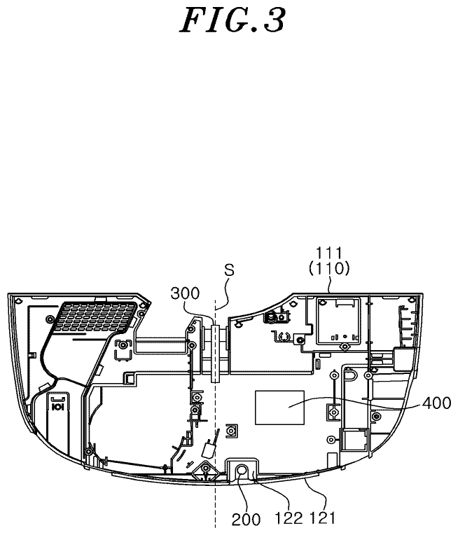

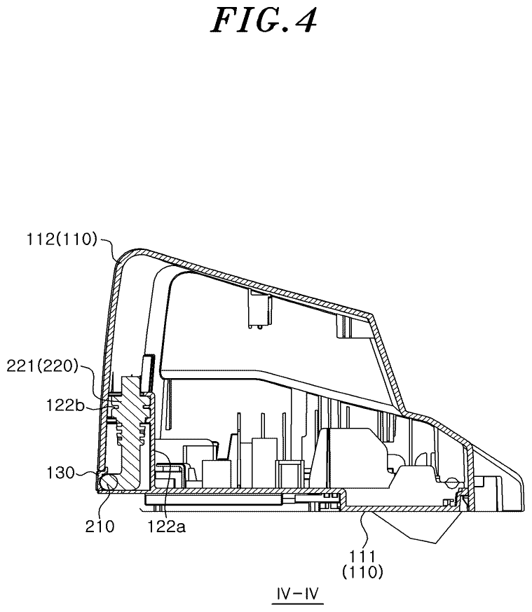

Referring further to FIGS. 3 and 4, the second guide part 122 can guide the arrangement direction of a second section 220 of the cable 200, which will be described later, inside the body part 110. In other words, the second guide part 122 may be covered by the upper housing 112. The second guide part 122 can guide the second section 220 such that the second section 220 is positioned on the front side of the first section 210 and extends in one direction different from the extension direction of the first section 210. The one direction may be an up-down direction. Further, the second guide part 122 may be positioned inside the body part 110 to be closer to the rear surface of the body part 110 than to the front surface of the body part 110. In addition, the second guide part 122 can guide the second section 220 so that the second section 220 does not overlap with an imaginary line S extending in the front-rear direction from the nozzle 300. In other words, the second guide part 122 may be positioned closer to the right side of the body part 110 than the nozzle 300. The second guide part 122 may include a support 122a and a locking portion 122b.

The support 122a may extend in the up-down direction and provide a support space for guiding the second section 220 of the cable 200 therein. A groove may be formed in the support 122a, the groove being recessed from the rear to the front and extending in the up-down direction to provide the support space. In addition, the support space may communicate with the guide space of the first guide part 121. The cable 200 can be guided in the up-down direction by the support 122a in the support space and then guided toward the left or right side of the body part 110 by the first guide part 121. In addition, the support 122a may be positioned closer to the rear side than the front side of the body part 110. For example, the rear side of the support 122a may be in contact with an inner surface of the upper housing 112. As another example, the rear side of the support 122a may be positioned inside the body part 110 such that a gap is formed between it and the upper housing 112, with the length in the front-back direction of the gap being smaller than the length in the front-back direction of a power bushing 221 of the second section 220, which will be described later. The second section 220 can be prevented from moving rearward and being separated from the second guide part 122 by the support 122a.

The locking portion 122b may protrude from the inner side of the support 122a and engage with the second section 220 of the cable 200. The second section 220 can be secured to the support 122a by the locking portion 122b. In other words, even when the user changes the arrangement direction of the first section 210, the cable 200 can be prevented from being separated from the cable guide 120.

The guide cover 130 may be coupled to the first guide part 121 to cover the first section 210 arranged in the first guide part 121. The first section 210 can be secured in the first guide part 121 by the guide cover 130. In other words, the user can fix the first section 210 by coupling the guide cover 130 to the first guide part 121 after arranging the first section 210 toward the left or right side of the body part 110 in the first guide part 121. In addition, the guide cover 130 may be coupled to the left guide portion 121a and the right guide portion 121b at the same time to cover the lower side of the second guide part 122.

The cable 200 can supply power to the circuit board 400 from outside the housing assembly 100. The arrangement direction of the cable 200 can be guided and supported by the cable guide 120. The cable 200 may include the first section 210 and the second section 220.

The first section 210 may be extended toward the left or right side of the body part 110 through the first guide part 121. In other words, the user can change the direction in which the first section 210 extends in the first guide part 121 to either the left or right side of the body part 110. In addition, the first section 210 can be positioned at the rear of the second section 220 by the first guide part 121. The first section 210 can be connected to an outlet located outside the bidet 1.

The second section 220 may be positioned inside the housing assembly 100 to connect the first section 210 and the circuit board 400. The second section 220 may be supported by the second guide part 122 to extend in a direction different from the extension direction of the first section 210. In other words, the second section 220 may extend in the up-down direction inside the body part 110 through the support 122a. On the second section 220, the power bushing 221 may be formed that is arranged in the up-down direction in the support space of the support 122a and engages with the locking portion 122b. The second section 220 can be fixed to the second guide part 122 through the power bushing 221.

The nozzle 300 may be supported on the body part 110 to spray cleaning liquid or other fluid into the toilet bowl or the front where the user is located. In addition, the nozzle 300 can be controlled by the circuit board 400 to move in the front-rear direction of the body part 110.

The circuit board 400 can control the nozzle 300 or supply power to the nozzle 300. The circuit board 400 is disposed inside the body part 110 and can feed power supplied via the cable guide 120 to the nozzle 300. In other words, the circuit board 400 can be electrically connected to the second section 220 and the nozzle 300.

Hereinafter, the operation and effects of the bidet 1 according to one embodiment of the present disclosure will be described.

The cable guide 120 of the bidet 1 guides a portion of the cable 200 to be selectively extended toward the left or right side of the body part 110 depending on the location of a wall outlet in a toilet, so that the bidet 1 can be easily installed in a toilet bowl regardless of the location of the external outlet. For example, when the external outlet is installed on the left side of the bidet 1, the first section 210 can be extended from the lower side of the second section 220 toward the left side of the body part 110 through the left guide portion 121a. Thereafter, when the installation location of the bidet 1 changes and the external outlet is installed on the right side of the bidet 1, the first section 210 can be extended from the lower side of the second section 220 toward the right side of the body part 110 through the right guide portion 121b.

Further, since the second section 220 of the cable 200 can be supported by the second guide part 122 to extend in a direction different from the extension direction of the first section 210, the direction of the first section 210 can be easily changed.

Furthermore, since the second section 220 of the cable 200 can be secured to the second guide part 122 by engaging the second section 220 with the locking portion 122b, the cable 200 can be prevented from being separated from the cable guide 120 due to the directional change of the first section 210.

In addition, since the guide cover 130 can be coupled to the first guide part 121, the first section 210 can be prevented from being separated from the first guide part 121.

Further, since the second guide part 122 is positioned close to the rear surface of the body part 110, the second section 220 can be restricted from being moved rearward by the body part 110, which prevents the second section 220 from being separated from the second guide part 122.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

1. A bidet comprising:
a nozzle for discharging liquid forward;
a circuit board for controlling the nozzle or supplying power to the nozzle;
a housing assembly accommodating the circuit board therein; and
a cable for supplying power to the circuit board from an outside of the housing assembly,
wherein the housing assembly includes a body part supporting the nozzle, and a cable guide for guiding an arrangement direction of the cable,
wherein the cable includes:
a first section disposed outside the housing assembly and extending from a rear end of the housing assembly; and
a second section disposed inside the housing assembly and connecting the first section with the circuit board,
wherein the cable guide includes a first guide part that guides an arrangement direction of the first section, and
wherein the first guide part is configured to guide the first section to extend from a rear end of the body part toward one of a left side or a right side of the body part when viewed from a rear side of the bidet, and allow the arrangement direction of the first section to be changed to the other of the left side and the right side.

2. The bidet of claim 1, wherein the cable guide further includes a second guide part that guides an arrangement direction of the second section within the body part, and
the second section extends in one direction different from an extension direction of the first section.

3. The bidet of claim 1, wherein the first section is disposed behind the second section.

4. The bidet of claim 2, wherein the one direction is an up-down direction.

5. The bidet of claim 2, wherein the first guide part is disposed at a lower end portion of the body part.

6. The bidet of claim 5, wherein the first guide part extends from the second guide part to the left side and the right side of the body part.

7. The bidet of claim 6, wherein the second guide part includes:
a support that extends in the one direction and provides a support space for guiding the second section of the cable within the support; and
a locking portion that protrudes from an inner side of the support and configured to engage with the second section of the cable.

8. The bidet of claim 7, wherein on the second section, a power bushing is formed that is arranged in an up-down direction in the support space of the support and engages with the locking portion.

9. The bidet of claim 6, wherein the first guide part includes:
a left guide portion which extends from a lower side of the second guide part toward the left side of the body part and provides a left guide space for accommodating the first section and guiding the first section to the left side of the body part, and
a right guide portion which extends from the lower side of the second guide part toward the right side of the body part and provides a right guide space for accommodating the first section and guiding the first section to the right side of the body part.

10. The bidet of claim 9, wherein a length in a left-right direction of one of the left guide portion and the right guide portion is formed to be longer than that of the other.

11. The bidet of claim 9, wherein the left guide portion and the right guide portion are formed such that depths in a front-rear direction of the left guide space and the right guide space decrease as the distance from the second guide part increases.

12. The bidet of claim 5, wherein the housing assembly further includes a guide cover coupled to the first guide part to cover the first section arranged in the first guide part.

13. The bidet of claim 6, wherein the second guide part is positioned inside the body part to be closer to a rear surface of the body part than to a front surface of the body part.

14. The bidet of claim 2, wherein the second guide part guides the second section of the cable so that the second section does not overlap with an imaginary line extending in a front-rear direction from the nozzle.
